(19) United States
(12) Patent Application Publication
(10) Pub. No.: US 2024/0065135 A1
(43) Pub. Date: Feb. 29, 2024

(54) MULTIPLE NETWORKS MONITOR

(71) Applicant: Precision Planting LLC, Tremont, IL (US)

(72) Inventors: Ryan Allgaier, East Peoria, IL (US); David Aaron WILCOXSON, Tremont, IL (US)

(21) Appl. No.: 18/260,635

(22) PCT Filed: Jan. 28, 2022
(86) PCT No.: PCT/IB2022/050761

§ 371 Date: Jul. 7, 2023

Related U.S. Application Data
(60) Provisional application No. 63/154,182, filed on Feb. 26, 2021.
(60) Provisional application No. 63/150,436, filed on Feb. 17, 2021.

(51) Int. Cl. A01C 7/08; A01C 21/00

(52) U.S. Cl. CPC A01C 7/081; A01C 21/007

(57) ABSTRACT

A monitor for an agricultural implement connected to a plurality of networks, such as a first network and a second network, with each network controlling equipment on its network.

### CROSS REFERENCE TO RELATED APPLICATIONS

This application claims priority to U.S. Provisional Application Nos. 63/150,436, filed 17 Feb. 2021, and 63/154,182, filed 26 Feb. 2021, the contents of each are incorporated herein by reference in their entireties.

### BACKGROUND

On a typical agricultural implement, there is one monitor and one network that controls all of the equipment on the agricultural implement. This works when all of the equipment is distributed in rows across the agricultural implement.

### BRIEF DESCRIPTION OF THE DRAWINGS

FIG. 1 is a schematic of an agricultural implement.

FIG. 2 is a schematic of a screen on a monitor.

FIG. 3 illustrates an implement topology for an agricultural implement 300 having multiple implement networks in accordance with one embodiment.

### DETAILED DESCRIPTION

All references cited herein are incorporated herein in their entireties. If there is a conflict between a definition herein and in an incorporated reference, the definition herein shall control.

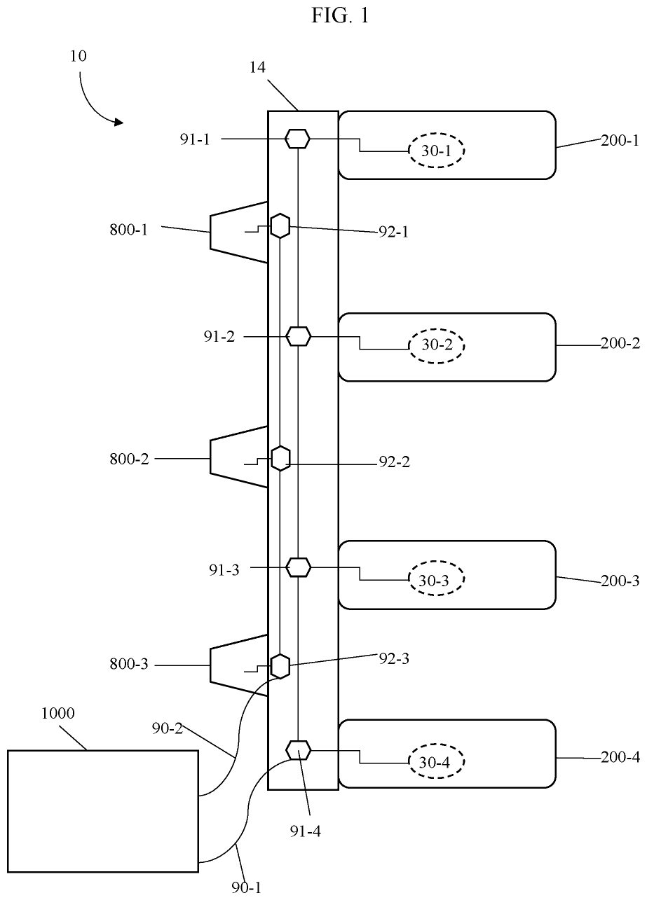

Referring to the drawings, wherein like reference numerals designate identical or corresponding parts throughout the several views, FIG. 1 illustrates an agricultural implement 10 having a toolbar 14. A plurality of row units 200 (200-1 to 200-4) are distributed along toolbar 14 to illustrate a row crop planter. The number of rows can be any number. While illustrated for a row crop planter, the agricultural implement can be any type of agricultural implement, such as an air seeder, sidedress bar, tillage implement, strip till implement, sprayer, or irrigation implement. Examples of agricultural implements can be found in PCT Publication Nos. WO2008/086318, WO2012/129442, WO2013/049198, WO2014/026183, and WO2014/018717.

Each row unit 200 (200-1 to 200-4) each have a seed meter 30 (30-1 to 30-4) disposed on the row unit 200. Each seed meter 30 (30-1 to 30-4) is connected to a first network 90-1 to monitor 1000. Examples of monitors 1000 are described in the above PCT Publications. In one example, a monitor preferably includes a graphical user interface (“GUI”), a memory, a central processing unit (“CPU”), and a bus node. The bus node preferably comprises a controller area network (“CAN”) node including a CAN transceiver, a controller, and a processor. The monitor is preferably in electrical communication with a speed sensor (e.g., a radar speed sensor mounted to a tractor) and a global positioning receiver (“GPS”) receiver mounted to the tractor (or in some embodiments to the toolbar 14).

Optionally, row controllers 91 (91-1 to 91-4) can be disposed along the first network 90-1 to control equipment at each row, such as seed meters 30 (30-1 to 30-4). Row controllers 91 are described in PCT Publication No. WO2014/018717.

A second network 90-2 is connected to monitor 1000. Connected to second network 90-2 are nozzles 800 (800-1 to 800-3). While illustrated with nozzles 800, any other equipment can be installed on second network 90-2. Optionally, row controllers 92 (92-1 to 92-3) can be disposed along the second network 90-2 to control equipment at each row.

The number or rows in each network can be the same or they can be different. Having separate networks works well when the number of rows are different. This can be done for controlling aspects for seeding on the first network 90-1 and for controlling chemical application, such as fertilizer, herbicide, insecticide, or pesticide, on the second network 90-2.

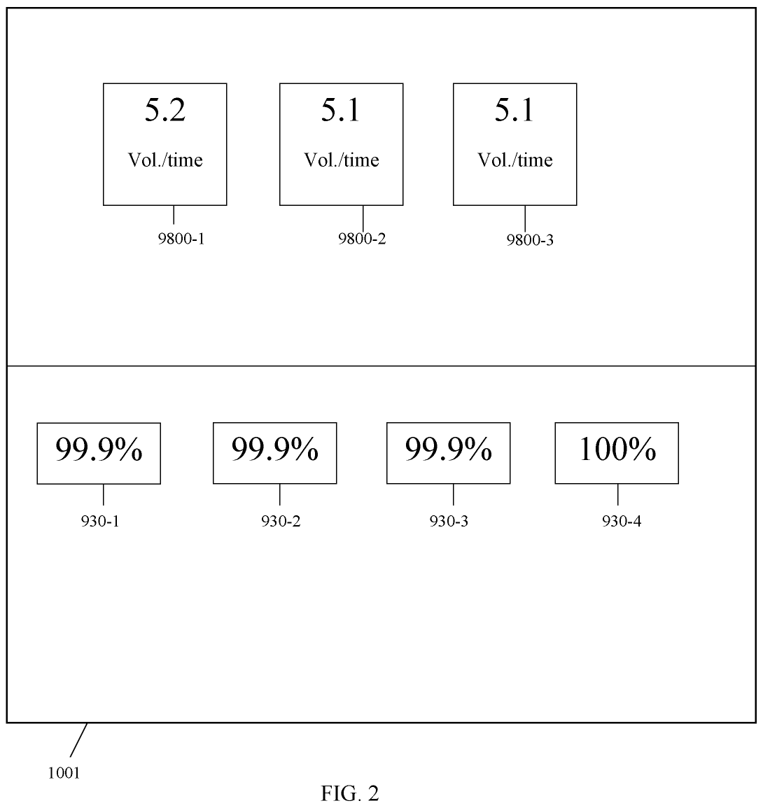

Monitor 1000 can display the performance of equipment from each network separately on a screen, or they can be displayed on a split screen. A split screen 1001 is illustrated in FIG. 2. For nozzles 800-1 to 800-3, the flow rates are displayed in windows 9800-1 to 9800-3, respectively. For seed meters 30-1 to 30-4, the percent singulations are displayed in windows 930-1 to 930-4, respectively.

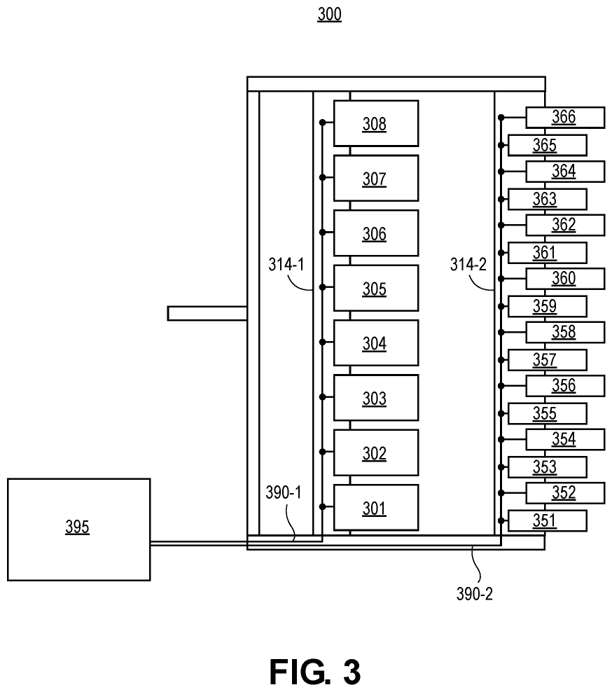

FIG. 3 illustrates an implement topology for an agricultural implement 300 having multiple implement networks in accordance with one embodiment. The implement 300 includes multiple toolbars 314-1 and 314-2 with each having different row units that are separately controlled by different networks 390-1 and 390-2. The multiple networks enable separate sub-implement areas to be controlled by a user separately with separate row spacing, system configuration, and user operation.

In one example, a plurality of row units 351-366 are distributed along toolbar 314-2 to illustrate a row crop planter. The number of rows can be any number and can have any spacing (e.g., 7.5″ spacing, 10″ spacing, 15″ spacing, 20″ spacing, 30″ spacing, etc.). While illustrated for a row crop planter, the agricultural implement 300 can be any type of agricultural implement, such as an air seeder, sidedress bar, tillage implement, strip till implement, sprayer, or irrigation implement.

Each row unit 350-366 may have a seed meter (not shown) disposed on the row unit. Each seed meter or row unit is connected to a network 390-2 to monitor 395. Optionally, row controllers (not shown) can be disposed along the network 390-3 to control equipment at each row, such as seed meters. Row controllers are described in PCT Publication No. WO2014/018717.

A network 390-1 is also connected to monitor 395. Connected to network 390-1 are row units 301-308. Each row unit may include one or more nozzles for fertilizer applications, or any other equipment can be installed on the network 390-1. Optionally, row controllers (not shown) can be disposed along the network 390-1 to control equipment at each row.

In one example, the toolbar 314-1 is a fertilizer bar that has separate row spacing (e.g., 15″ spacing, 20″ spacing, 30″ spacing, etc.), installed components, and control from the toolbar 314-2.

The number or rows in each network can be the same or they can be different. Having separate networks works well when the number of rows are different. This can be done for controlling aspects with a single monitor for seeding on the network 390-2 and for controlling chemical application, such as fertilizer, herbicide, insecticide, or pesticide, on the network 390-1. A single monitor is able to have multiple parallel implement controls at the same time.

### EXAMPLES

The following are nonlimiting examples.

Example 1—an agricultural system comprising: a monitor; a plurality of networks connected to the monitor; each network is configured to control equipment on each network.

Example 2—the agricultural system comprising of Example 1, wherein the plurality of networks comprises a first network and a second network.

Example 3—the agricultural system of any preceding Example, wherein the equipment is distributed in rows on an agricultural implement.

Example 4—the agricultural system of Example 3, wherein a number or rows in the first network is different from a number of rows in the second network.

Example 5—the agricultural system of Example 3 or 4, wherein the agricultural implement is a row crop planter.

Example 6—the agricultural system of Examples 3 to 5, wherein the first network controls equipment for seeding, and the second network controls equipment for chemical application.

Example 7—the agricultural system of any preceding Example, wherein performance of equipment is displayed on a screen on the monitor.

Example 8—the agricultural system of Example 2, wherein performance of equipment on the first network and equipment on the second network are both displayed on split screen on the monitor.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures but is to be accorded the widest scope consistent with the spirit and scope of the appended claims.

1. An agricultural system comprising:
a monitor;
a plurality of networks connected to the monitor;
each network is configured to control equipment on each network.

2. The agricultural system of claim 1, wherein the plurality of networks comprises a first network and a second network.

3. The agricultural system of claim 1, wherein the equipment is distributed in rows on an agricultural implement.

4. The agricultural system of claim 3, wherein a number of rows in the first network is different from a number of rows in the second network.

5. The agricultural system of claim 3, wherein the agricultural implement is a row crop planter.

6. The agricultural system of claim 3, wherein the agricultural implement is an air seeder.

7. The agricultural system of claim 3, wherein the first network controls equipment for seeding, and the second network controls equipment for chemical application.

8. The agricultural system of claim 1, wherein performance of equipment is displayed on a screen on the monitor.

9. The agricultural system of claim 2, wherein performance of equipment on the first network and equipment on the second network are both displayed on split screen on the monitor.
